(19) United States
(12) Patent Application Publication
(10) Pub. No.: US 2006/0184843 A1
(43) Pub. Date: Aug. 17, 2006

(54) Data recording using carbon nanotube electron sources

(76) Inventor: William S. Oakley, SAN JOSE, CA (US)

Correspondence Address: PERKINS COIE LLP, P.O. BOX 2168, MENLO PARK, CA, 94026, US

(21) Appl. No.: 10/545,485

(22) PCT Filed: Feb. 13, 2004
(86) PCT No.: PCT/US04/04125

§ 371 Date: Aug. 12, 2005

Related U.S. Application Data
(60) Provisional application No. 60/447,528, filed on Feb. 14, 2003.

(51) Int. Cl. G06F 11/00

(52) U.S. Cl. 714/100

(57) ABSTRACT

A method and apparatus for data recording using carbon nanotube electron sources is described. The present invention relates to using a Carbon Nanotube as a source for an electron beam suitable for real-time writing of data to a storage medium. Carbon nanotube electron emitters are used as electron sources for recording data marks onto various recording media. In one embodiment, the invention is an apparatus. The apparatus includes a substrate. The apparatus further includes a carbon nanotube mounted on the substrate. The apparatus also includes an extraction electrode mounted in proximity to a tip of the carbon nanotube.

### FIELD

The present invention, in some embodiments, generally relates to the field of data recording and more specifically to recording data on media using Carbon Nanotube electron emitters.

### BACKGROUND

Direct write electron beam writing has been used in lithography for wafer fabrication or mastering of optical discs. These systems typically use a 0.2 to 0.5 micron wide e-beam in a vacuum to expose a resist coated onto a substrate. In wafer fabrication the e-beam is typically modulated and scanned in a raster format to form an exposed pattern or image on a resist coated on a substrate. In optical disc mastering the resist coated disc is rotated beneath an e-beam. Neither of these applications relates to real-time data recording and neither is known to use Carbon Nanotubes.

### SUMMARY

A method and apparatus for data recording using carbon nanotube electron sources is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. Thus, the description is illustrative of the invention, rather than limiting on the invention.

In one embodiment, the invention is an apparatus. The apparatus includes a substrate. The apparatus further includes a carbon nanotube mounted on the substrate. The apparatus also includes an extraction electrode mounted in proximity to a tip of the carbon nanotube. The apparatus may further include a focus electrode mounted in proximity to the carbon nanotube. The apparatus may further include a deflection electrode mounted in proximity to the tip of the carbon nanotube. The apparatus may also include an anode mounted a small distance from the extraction electrode. The apparatus may further include a container mounted on the substrate in proximity to the tip of the carbon nanotube. The container may be of various geometric forms, such as cylindrical for example. Moreover, the apparatus may have the container when formed of dielectric material. Additionally, the apparatus may include a detector mounted in proximity to a first end of the container opposite a second end of the cylindrical container. The apparatus may have an anode located in proximity to the first end of the container. The second end of the cylindrical container is mounted in proximity to the tip of the carbon nanotube. Moreover, the apparatus may a detector electrode as the detector. Additionally, the substrate of the apparatus may have a cavity in a surface of the substrate with the carbon nanotube mounted within the cavity. Furthermore, the extraction electrode may be mounted on the surface of the substrate surrounding the cavity. Likewise, the apparatus may include a window mounted on the first end of the container, with the detector mounted on the window outside the container.

In an alternate embodiment, the invention is a disk drive. The disk drive includes a media receptacle. The disk drive also includes an actuator to move within the disk drive in proximity to a location of any media within the media receptacle. The disk drive further includes a read/write head coupled to the actuator. The head includes a substrate, a carbon nanotube mounted on the substrate, and an extraction electrode mounted in proximity to a tip of the carbon nanotube.

In another alternate embodiment, the invention is a method of writing data. The method includes emitting electrons from a carbon nanotube. The method also includes modulating electron beams from the carbon nanotube. The method further includes recording a mark on a medium using electrons from the carbon nanotube. The method may also include focusing the electrons on the medium. The method may further include passing the electrons through a window to the medium. Moreover, the method may include deflecting the electrons.

In yet another alternate embodiment, the invention is a disk drive. The disk drive includes an enclosed medium. The disk drive further includes an actuator positioned to move within the disk drive in proximity to the medium. The disk drive also includes a read/write head coupled to the actuator. The head includes a substrate, a carbon nanotube mounted on the substrate, and an extraction electrode mounted in proximity to a tip of the carbon nanotube.

In still another alternate embodiment, the invention is a method of reading data. The method includes emitting electrons from a carbon nanotube. The method further includes electrons returning from or emitted by a mark on a medium. The method also includes detecting the electrons after they leave the media. The method may further include passing the electrons through a window to the medium. The method may also include focusing the electrons on the medium. Additionally, the method may include modulating the electron beam from the carbon nanotube.

In yet another alternate embodiment, the invention is a tape drive. The tape drive includes a media receptacle. The tape drive also includes a read/write head positioned in proximity to the media receptacle. The head includes a substrate, a carbon nanotube mounted on the substrate, and an extraction electrode mounted in proximity to a tip of the carbon nanotube.

In still another embodiment, the invention is a method of forming a carbon nanotube-based read/write head. The method includes placing a carbon nanotube on a substrate. The method further includes forming an electrode in proximity to the carbon nanotube. The method also includes attaching a dielectric container to the substrate with the container being a cylinder circumscribing the electrode and the carbon nanotube. Moreover, the method includes sealing the dielectric container in a vacuum with a window. Additionally, the method includes forming a detector on the outer surface of the window opposite the container. The method may also include forming an anode on an inner surface of the window connected to the container. The method may further include forming an electrode in proximity to the carbon nanotube. The method may also involve the electrode including a focus electrode and an extraction electrode. Moreover, the method may involve the carbon nanotube placed within a cavity of the substrate.

In yet another alternate embodiment, the invention is a method of reading data. The method includes emitting electrons from a carbon nanotube. The method also includes emitting secondary electrons from a mark on a medium. The method further includes detecting the secondary electrons.

In a further alternate embodiment, the invention is an apparatus for storing data on a medium. The apparatus includes means for emitting electrons. The apparatus also includes means for directing the electrons to the medium. The apparatus may further include means for maintaining the means for emitting and the means for directing within a vacuum. The apparatus may also include means for supporting the means for emitting, the means for directing and the means for maintaining.

### BRIEF DESCRIPTION OF THE DRAWINGS

The present invention is illustrated in various embodiments by way of example and not limitation in the accompanying figures, in which like numbers represent like or similar components.

FIG. 1 illustrates a relationship between distance from a beam source and corresponding beam width.

FIG. 2a illustrates an embodiment of an apparatus useful in producing an electron beam using a Carbon Nanotube.

FIG. 2b illustrates an alternate embodiment of an apparatus useful in producing an electron beam using a Carbon Nanotube.

FIG. 3 illustrates another alternate embodiment of an apparatus useful in producing an electron beam using a Carbon Nanotube.

FIG. 4 illustrates an embodiment of a method of using a storage device using a Carbon Nanotube.

FIG. 5 illustrates an alternate embodiment of a method of using a storage device using a Carbon Nanotube.

FIG. 6a illustrates an embodiment of an apparatus that may be used for recording on media.

FIG. 6b illustrates an alternate embodiment of an apparatus that may be used for recording on media.

FIG. 7 illustrates yet another alternate embodiment of an apparatus useful in producing an electron beam using a Carbon Nanotube.

FIG. 8 illustrates an embodiment of a method of making a storage device using a Carbon Nanotube.

FIG. 9 illustrates an embodiment of a method of using a storage device including a Carbon Nanotube.

### DETAILED DESCRIPTION

A method and apparatus for data recording using carbon nanotube electron sources is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, the invention is an apparatus. The apparatus includes a substrate. The apparatus further includes a carbon nanotube mounted on the substrate. The apparatus also includes an extraction electrode mounted in proximity to a tip of the carbon nanotube. The apparatus may further include a deflection electrode mounted in proximity to the tip of the carbon nanotube. The apparatus may also include an anode mounted separately from the extraction electrode. The apparatus may further include a container mounted on the substrate in proximity to the tip of the carbon nanotube. Moreover, the apparatus may have the container when formed of dielectric material. Additionally, the apparatus may include a detector mounted in proximity to a first end of the container opposite a second end of the container. The second end of the container is mounted in proximity to the tip of the carbon nanotube. Moreover, the apparatus may a detector electrode as the detector in proximity to the first end of the container. Additionally, the substrate of the apparatus may have a cavity in a surface of the substrate with the carbon nanotube mounted within the cavity. Furthermore, the extraction electrode may be mounted on the surface of the substrate surrounding the cavity. Likewise, the apparatus may include a window mounted on the first end of the container, with the detector mounted on the window outside the container.

In an alternate embodiment, the invention is a disk drive. The disk drive includes a media receptacle. The disk drive also includes an actuator to move within the disk drive in proximity to a location of any media within the media receptacle. The disk drive further includes a read/write head coupled to the actuator. The head includes a substrate, a carbon nanotube mounted on the substrate, and an extraction electrode mounted in proximity to a tip of the carbon nanotube. In another alternate embodiment, the invention is a method of writing data.

The method includes emitting electrons from a carbon nanotube. The method also includes modulating electrons from the carbon nanotube. The method further includes recording a mark on a medium using electrons from the carbon nanotube. The method may also include focusing the electrons on the medium. The method may further include passing the electrons through a window to the medium. Moreover, the method may include deflecting the electrons.

In yet another alternate embodiment, the invention is a disk drive. The disk drive includes an enclosed medium. The disk drive further includes an actuator positioned to move within the disk drive in proximity to the medium. The disk drive also includes a read/write head coupled to the actuator. The head includes a substrate, a carbon nanotube mounted on the substrate, and an extraction electrode mounted in proximity to a tip of the carbon nanotube.

In still another alternate embodiment, the invention is a method of reading data. The method includes emitting electrons from a carbon nanotube. The method further includes detecting electrons returning from or emitted by a mark on a medium. The method also includes detecting the electrons after their interaction with the media. The method may further include passing the electrons through a window to the medium. The method may also include focusing the electrons on the medium. Additionally, the method may include modulating the electron beam from the carbon nanotube.

In yet another alternate embodiment, the invention is a tape drive. The tape drive includes a media receptacle. The tape drive also includes a read/write head positioned in proximity to the media receptacle. The head includes a substrate, a carbon nanotube mounted on the substrate, and an extraction electrode mounted in proximity to a tip of the carbon nanotube.

In still another embodiment, the invention is a method of forming a carbon nanotube-based read/write head. The method includes placing a carbon nanotube on a substrate. The method further includes forming an electrode in proximity to the carbon nanotube. The method also includes attaching a dielectric container to the substrate with the container circumscribing the electrode and the carbon nanotube. Moreover, the method includes sealing the dielectric container with a window to enclose a vacuum. Additionally, the method includes forming a detector on a surface of the window opposite the container. The method may also include forming an anode on an inner surface of the window connected to the container. The method may further include forming an electrode in proximity to the carbon nanotube. The method may also involve the electrode including a focus electrode and an extraction electrode. Moreover, the method may involve the carbon nanotube placed within a cavity of the substrate.

In yet another alternate embodiment, the invention is a method of reading data. The method includes emitting electrons from a carbon nanotube. The method also includes emitting secondary electrons from a mark on a medium. The method further includes detecting the secondary electrons.

In a further alternate embodiment, the invention is an apparatus for storing data on a medium. The apparatus includes means for emitting electrons. The apparatus also includes means for directing the electrons to the medium. The apparatus may further include means for maintaining the means for emitting and the means for directing within a vacuum. The apparatus may also include means for supporting the means for emitting, the means for directing and the means for maintaining.

The present invention relates generally to using a Carbon Nanotube as a source for an electron beam suitable for real-time writing of data to a storage medium. Carbon Nanotube electron emitters are used as electron sources for recording data marks onto various recording media. E-beam writing has generally not been used directly for real-time data storage. Similarly, carbon nanotubes have not previously been used as electron sources for e-beam recording, or for resist exposure on wafer substrates or discs.

A data storage system may use the electron beam emitted from a single carbon nanotube impinging onto a sensitive recording media and thereby recording a mark corresponding to an input data signal that controls the nanotube output to the media. The input signal data may be converted to either analog or digital modulation of the emitted electron beam either at the nanotube or otherwise but before reaching the recording media. The carbon nanotube emitter may be in close proximity to the recording media such that no electron lens system is required to form the desired recorded mark size. Alternatively, an electron lens system may be interposed between the emitter and the recording media such that the emitted beam is focused to write a recorded mark on the media.

The emitter and media may both be located in a vacuum enclosure. Alternatively, the emitter may be located in a vacuum enclosure and the recording media may reside in a-gaseous domain either at atmospheric or reduced pressure. Similarly, the emitter may be located in a vacuum enclosure and the recording media may reside in a liquid domain. The recording media may be in the form of a rotating disc or the form of a long translating tape. The recording media may either be of a reversible (or erasable nature) or of a permanent archival nature. Similarly, the recording media may be sensitive to either radiation by electrons or thermally sensitive and undergo a change so as to record a data mark. Alternatively, the recording media may be a material that undergoes a phase change when subjected to the electron beam energy.

The recording media may be either preformatted or unformatted media. The recording media may either use or not use a protective layer over the sensitive layer with either a thin or substantially thicker protective layer. The media may have an electron permeable upper layer.

The e-beam may pass through an electron permeable membrane between the nanotube emitter and the recording media. The electron permeable membrane may be placed so as to enable the nanotube emitter and an electron lens to operate in a vacuum environment while interacting with recording media which is not in vacuum.

Systems may use a multiplicity of similar nanotube emitters arranged in a specific pattern to form a similar pattern of beams impinging on the recording media, some or all of which produce recorded marks. The array pattern of nanotube emitters can be distributed in one, two, or three dimensions as appropriate for the specific system design. Each nanotube in the array may be individually modulated by a data or formatting signal. Some selected nanotube emitters in the array of multiple emitters may be used for tracking formating and/or data marks. The nanotube emitter assembly may be mounted on a moving element to enable accurate tracking of recorded formating marks and recorded data marks via a servo system that drives the moving assembly. The emitter assembly may contain a means of beam deflection to move the recording/reading beam array in a transverse manner to enable precision tracking of the recorded data and format marks and where such deflection means is either electrostatic or electromagnetic in nature.

The emission by carbon nanotubes of electron beams of significant power, nearly collimated, and with a small spread in electron velocities make these devices useful as sources for advanced electron beam data recorders. The recorder design can encompass either a single nanotube or an array of nanotubes in a preferred pattern and can enable either rotating disc or tape recorder designs of very high capacity and data rate. The basic design approaches can be defined by two parameters. One is wherein the carbon nanotube is either located in close proximity to the recording surface, or is located further from the recording surface necessitating an electron lens to refocus the beam to a desirably small size at the recording media sensitive surface. The second is whether the recording media is either located in the same vacuum enclosure as the emitting e-beam source, or a means is provided whereby the recording media can be located in another region, such as one containing gasses at atmospheric or reduced pressure for example. In this circumstance an electron permeable membrane is useful to maintain the emitting nanotube in a vacuum.

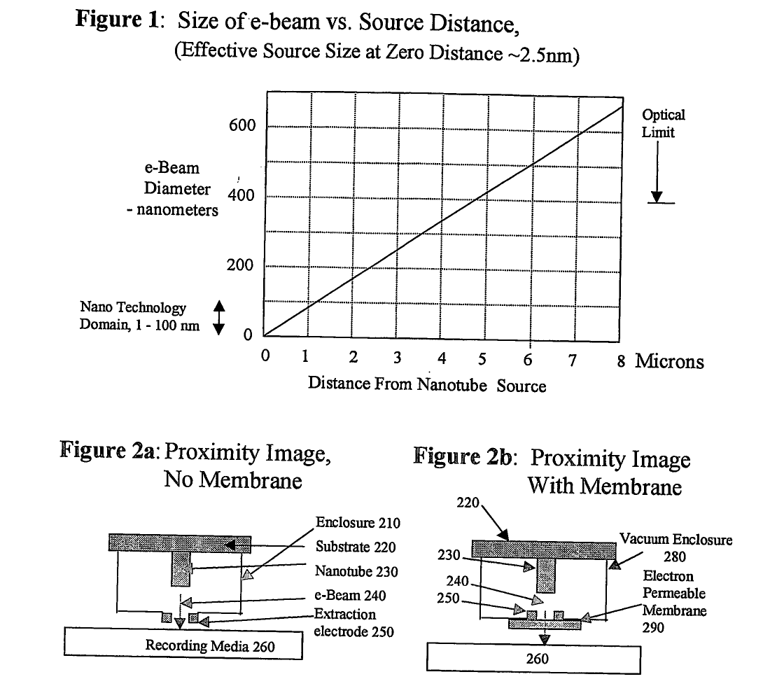

In one embodiment, a recorder system allows the media to be removed and replaced by another media volume or removed and placed in another similar recorder or reader. This involves the carbon nanotube emitting source (CNTES), or array of such sources, either located very close to the recording media or located in a vacuum enclosure separated from the media by an electron permeable membrane. In a close proximity design, the electron permeable membrane may be located between the CNTES and the media and preferably as close to the media as is mechanically possible. For disc systems this may be on the order of a micron, but for tape systems may be substantially greater due to the dynamics of tape motion. As seen from FIG. 1, the electron beam emanating from a typical carbon nanotube appears as though from a very small source, somewhat smaller than the diameter of the nanotube, and slowly expands with increasing distance from the source. The e-beam diameter is about 100 nanometers at a distance of 1.2 microns from the CNTES, easily compatible with flying a read/write head at this height above a media surface. Typical head flying heights in (sealed) hard disc drives are small fractions of a micron, compatible with beam diameters of 10 nanometers of less. In high-speed tape systems the tape flying height is typically about 1 micron above the magnetic head or above the tape support member for optical tape drives. The flying head concept for proximity located CNTES without and with an electron permeable membrane are shown in FIGS. 2a and 2b.

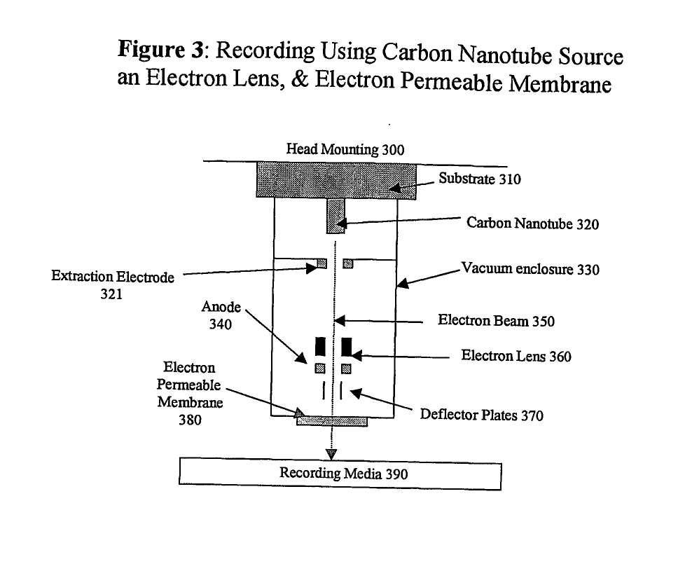

In systems employing an electron lens to focus the beam onto the media the electron permeable membrane may be located as close to the media as practical, and lies between the electron lens and the media as shown in FIG. 3. Separation distances between the media surface and the membrane of from a few up to the order of 100 microns may be feasible.

In designs where an electron permeable membrane is employed the electron accelerating voltage can be substantially increased to improve membrane penetration with voltages in the 1 kv to 3 kV (one to three kilovolt) range being preferred. This increased voltage also increases the power of the electron beam, for example a 200 nanoamp current at 3 kV provides a beam power of 0.6 milliwatts. In a beam diameter of 50 nm for example, this is a power density of about 2×10⁶ Watts per square centimeter. To avoid damage to the membrane it may be advantageous to locate an electron lens inside the vacuum region and configure the beam geometry so the beam diameter at the membrane is relatively large, thus minimizing the power density. This lens should bring the beam to focus outside of the vacuum region and at the sensitive layer in the recording media.

A thin dielectric membrane of heat resisting material possessing high mechanical strength may be useful, such as a thin sheet of silicon nitride, boron carbide, silicon carbide, or similar material. The thin membrane, typically several tens of nanometers thick, may be attached to the container or enclosure and cover an aperture or window through which the beam can pass. In one embodiment, the aperture in the enclosure is elongated enabling the beam to be deflected for tracking purposes if desired. A minimum sized aperture may be useful to minimize gas leakage into the vacuum enclosure and also to minimize the force on the membrane due to the difference in pressures inside and outside the container. For example, a membrane covering an aperture of 0.1×0.4 mm has to withstand a nominal force of approximately 0.5 grams at one atmosphere pressure.

In all embodiments, a means of tracking format marks or data tracks may be useful. Dynamic tracking of these marks by electrostatic or magnetic deflection of the e-beam, or array of beams, may easily be achieved but is only viable for small off-axis deflections. This small deflection is typically adequate to compensate for track run-out on a given track, but is typically not sufficient to provide for cross track access. For this reason the CNTES and electron lens, if any, and electron permeable membrane if any, may be located on a movable read/write head that provides cross track motion. Both cross track seek and track following may be achieved by servo control systems using feedback.

Turning to further details of the figures, FIG. 1 illustrates a relationship between distance from a beam source and corresponding beam width. The beam width increases roughly linearly with distance from the source. Optically visible light has a limit of about 400 nm, and nanotechnology typically operates in the 1-100 nm area. At a distance of about 1.2 microns from the source, a 100 nm wide beam may be expected as described above.

FIG. 2a illustrates an embodiment of an apparatus useful in producing an electron beam using a Carbon Nanotube. Such a beam may be expected to have a width predictable based on the graph of FIG. 1. An enclosure 210 may be part of a head assembly. Within the enclosure 210, typically affixed to one or more surfaces of the enclosure 210 is substrate 220. Mounted on substrate 220 is nanotube 230, such as a carbon nanotube. Emitted from nanotube 230 is electron beam 240, which may be used to record a mark on recording media 260. Recording media 260 may be a disk or tape having a surface or layer that is sensitive to electrons of electron beam 240. The extraction electrode 250 helps cause the electron beam 240 to be emitted from nanotube 230, such as by creating a potential (voltage) difference between the nanotube 230 and the electrode 250 (such as by using an outside source of voltage differential coupled to both of nanotube 230 and electrode 250).

FIG. 2b illustrates an alternate embodiment of an apparatus useful in producing an electron beam using a Carbon Nanotube. Unlike FIG. 2a, this embodiment uses a vacuum enclosure 280 on which is mounted substrate 220. An electron permeable membrane 290 is used to seal the opening through which the electron beam 240 passes, thereby allowing for a sealed vacuum environment for the nanotube 230 and a non-vacuum environment for media 260.

FIG. 3 illustrates another alternate embodiment of an apparatus useful in producing an electron beam using a Carbon Nanotube. Head mounting 300 is the head assembly in which this is incorporated. Vacuum enclosure 330 is mounted on mounting 300. Substrate 310 is mounted within enclosure 330, such as by mounting to the end of enclosure 330. Nanotube 320 is affixed to substrate 310, allowing for electrical and mechanical connections. Anode 340 is mounted within enclosure 330, allowing for generation of a potential difference between the anode 340 and extraction electrode 321. Electron beam 350 is produced in response to a potential difference between the carbon nanotube 320 and the extraction electrode 321, is accelerated by the potential difference between the extraction electrode 321 and the anode 340, and may be focused by electron lens 360, and/or deflected by deflector plates 370, before passing through electron permeable membrane 380 and out of enclosure 330 to make a mark on recording medium (or media) 390.

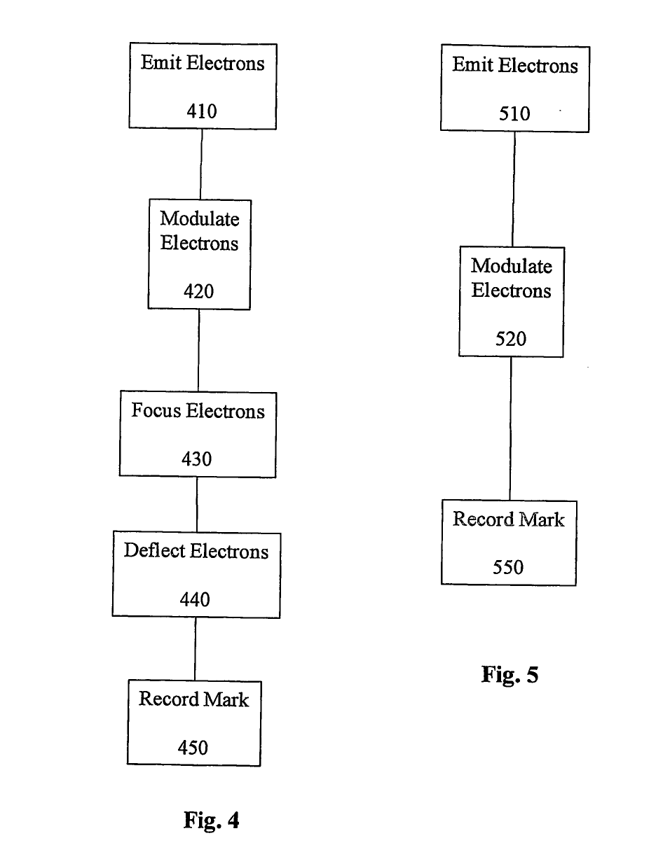

Various methods of using storage devices may be suitable depending on design and operating conditions. FIG. 4 illustrates an embodiment of a method of using a storage device using a Carbon Nanotube. At block 410, electrons are emitted, such as in response to a potential difference between a nanotube and the extraction electrode. At block 420, the electron beam intensity is modulated, such as by varying the extraction electrode voltage (not shown in the illustrations). Such a modulation may be used to either selectively block the electrons, or modulate the beam intensity. The modulator 420 may also include a means of beam deflection to selectively deflect the electrons, in response to a deflection signal. At block 430, the electrons of the beam formed by the emitted electrons are focused. At block 440, the electrons are deflected to correct for deviations from a path expected during design of the system. At block 450, the electrons record a mark on a recording medium.

FIG. 5 illustrates an alternate embodiment of a method of using a storage device using a Carbon Nanotube. At block 510, electrons are emitted, such as from a carbon nanotube. At block 520, the electrons are modulated based on a modulation signal. At block 550, the electrons record a mark on-a recording medium. In the processes of both FIGS. 4 and 5, blocks may be reordered, rearranged, or combined, depending on design constraints and preferences, within the spirit and scope of the present invention. For example, modulation may relate to whether electrons are emitted or not, rather than whether electrons already emitted ultimately reach a recording medium.

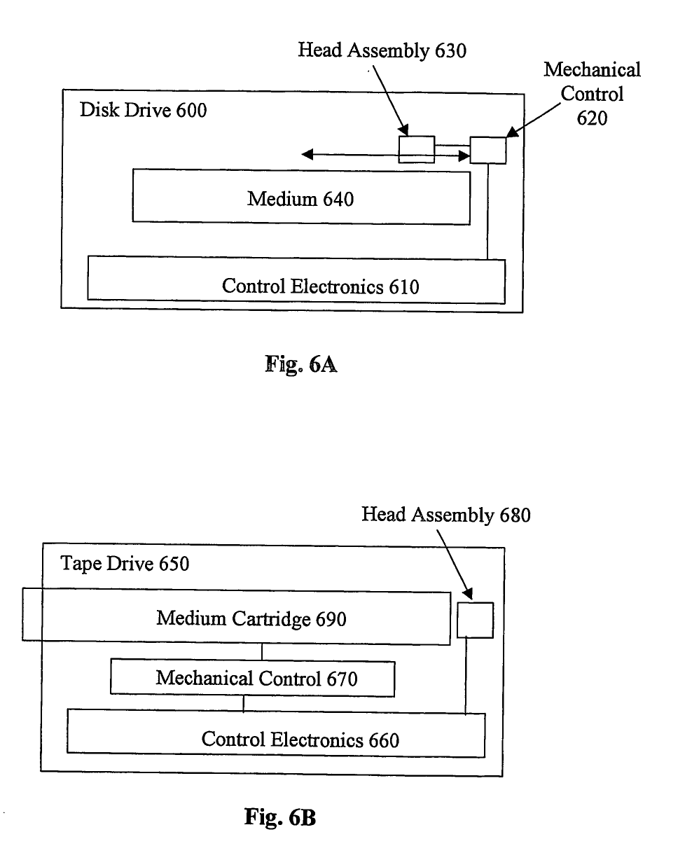

The embodiments of methods and apparatuses previously described may be used in various systems. FIG. 6a illustrates an embodiment of an apparatus that may be used for recording on media. Disk drive 600 includes control electronics 610, mechanical control 620, head assembly 630, and medium 640. Note that multiple similar or identical components may be included, such as a set or media 640 and corresponding set of head assemblies 630 and mechanical controls 620. In one embodiment, an interface with control electronics 610 allows for communication with components attached to or coupled to disk drive 600. Control electronics 610 controls mechanical control 620. Mechanical control 620 actuates head assembly 630, causing the head assembly to move in a range between a center and edge limit. Media 640 is a disk which may be spun on a spindle (not shown) for example, such that the head assembly may effectively move to any location on media 640 and either record or read data. Head assembly, in some embodiments, is implemented using embodiments such as those illustrated in FIGS. 2a, 2b and 3 for example.

FIG. 6b illustrates an alternate embodiment of an apparatus that may be used for recording on media. Tape drive 650 includes control electronics 660, mechanical control 670, head assembly 680, and space for medium cartridge 690. Medium cartridge 690 is a self-contained tape cartridge allowing for access to the tape near the location head assembly 680 and manipulation of the tape (on spools for example) by mechanical control 670. Head assembly 680 and mechanical control 670 operate responsive to control electronics 660. Control electronics 660 may interface with external components to receive and send data.

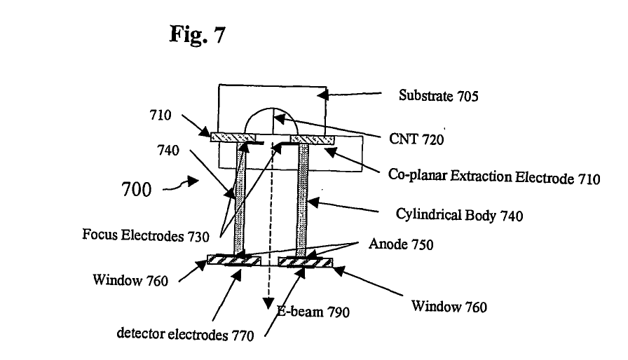

As described above, FIG. 3 illustrates an embodiment of a very small read/write head using a CNT as an electron emitter. In alternate embodiments, several of these components can be combined to facilitate device fabrication. An alternate embodiment of a read write head 700 may be as shown in FIG. 7, where an extraction electrode 710 with a central aperture is placed near the CNT 720 and is maintained at ground electrical potential. The CNT 720 tip may be located a micron or two (for example) from the extraction electrode 710 and is preferably precisely centered on the electrode aperture. The CNT 720 may be maintained at a few volts negative relative to the extraction electrode 710. Modulation of the emitted e-beam 790 may then be achieved by reducing the extraction electrode 710 voltage to at or below the CNT 720 voltage, thus gating the e-beam 790 current. With the appropriate drive circuits, modulation at a rate of hundreds of gigahertz or higher may be achievable.

As illustrated in this embodiment, substrate 705 includes a cavity that includes CNT 720. Extraction electrodes 710 are preferably formed on an approximately planar surface of substrate 705 in one embodiment. Focus electrodes 730 may then be formed along with extraction electrodes 710 or in a nearby location, allowing for focus and/or deflection of emitted e-beam 790. Cylindrical dielectric body 740 may surround the aperture through extraction electrodes 710 and/or focus electrodes 730. Closing cylindrical dielectric body 740 may be window or cover 760, which preferably is electron permeable but relatively vacuum-proof (allows for maintenance of an evacuated environment within body 740). Within body 740 on or near window 760 are formed anode(s) 750. Outside of window 760 are formed detectors (detector electrodes for example) 770.

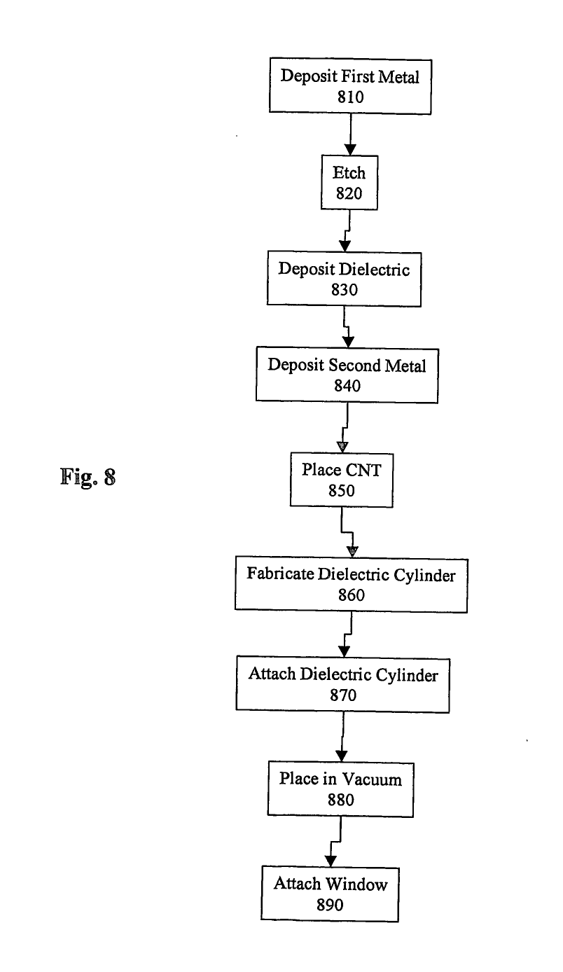

The embodiment of FIG. 7 may be produced using a method such as the method illustrated in FIG. 8 for example. In one embodiment, the fabrication of the extraction electrode is by metal deposition onto a wafer substrate that is then etched away to leave the electrode patterned as a disc with a central aperture and connecting traces. In such an embodiment, a dielectric layer may then be deposited onto the extraction electrode to insulate the electrode from further depositions. Additionally, in such an embodiment, a second metallic deposition of an annular electrode segmented into quadrants may be placed onto the dielectric to form a focus electrode. These electrode quadrants may form an annular ring that lies outside the extraction electrode disc and is nearly co-planar. In such an embodiment, adjusting the voltage of all of the electrode segments in unison may allow for focusing the e-beam. Placing slightly different voltages on the appropriate electrode quadrants may enable the e-beam to be deflected away from the beam (z) axis in either or both x and y directions. Thus, the extraction electrode, the focus electrode and the deflection electrodes may be fabricated in a single structure, thereby eliminating the need for separate electrode structures within the read/write head body (enclosure).

In such an embodiment, the entire microscale read/write head may be fabricated in three pieces prior to assembly. First the CNT emitter with the extraction electrode and focus/deflection electrodes is fabricated. Next, a body of dielectric is fabricated and attached to the emitter assembly. The combined assembly is then placed in a vacuum of approximately 10⁻⁸ torr (for ensample) and the window is attached, sealing the CNT head assembly. The window consists of a silicon membrane typically 30 nanometers thick (for example) mounted in a carrier with a circular anode on the inner surface (for electron acceleration) and a read detector electrode on the outer surface. Both anode and detector electrodes preferably have connections or couplings to electrical circuits.

Thus, FIG. 8 may also be described as a process including a set of modules. At module 810, the first metal deposition (initial electrode) occurs. At module 820, the first metal is etched (initial electrode etch). At module 830, the dielectric is deposited. At module 840, the second metal is deposited (annular electrode deposition). At module 850, the CNT emitter is placed within the central aperture. At module 860, the dielectric enclosure or body is fabricated. At module 870, the dielectric body is attached to the CNT emitter structure. At module 880, the combined structure is placed in a vacuum. At module 890, the window with electrodes is attached.

In one embodiment, the read write data storage system may be implemented with a higher beam power causing a change in the recording media that is then detectable by a lower power read beam by either secondary emission of electrons or by e-beam fluorescence.

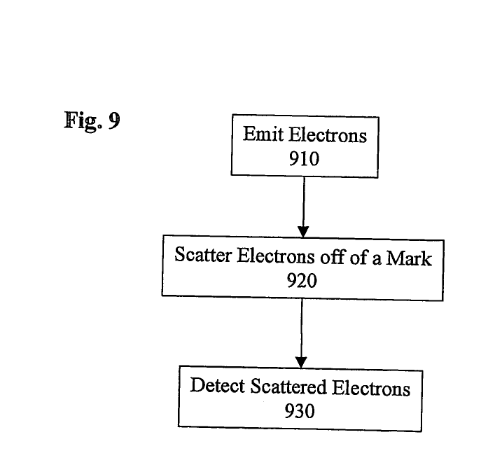

FIG. 9 illustrates an embodiment of a method of using a storage device including a Carbon Nanotube. Reading marks made by a carbon nanotube is a necessary operation to use the carbon nanotube for data storage. At module 910, an e-beam is emitted. At module 920, the e-beam illuminates a mark on a storage medium. Note that the e-beam may need to be deflected and/or focused, too. At module 930, electrons from the mark, such as secondary electrons, are detected by a detector. Such a detector may use either secondary emission of electrons or alternately detect photons emitted from the mark by e-beam fluorescence, for example.

Alternate Design Material

The Carbon Nano Tube is preferred as a nanoscale electron emitter due to several inherent characteristics arising from its carbon composition. Another option would be to use a silicon nano tip in a similar structure where the radius of the tip is similar to the radius of the nanotube, e.g. a few nanometers, providing similar source sizes. However, in similar designs the electron current emission capability of a CNT is at least ten times that of a silicon tip for several reasons. Firstly the CNT is essentially a single molecule of carbon and has greater electrical conductivity than silicon. This permits greater current through the CNT than the silicon tip for any given degree of resistive heating, which is a typical limiting factor in performance. Secondly, the CNT has a higher melting temperature than silicon so it is better able to withstand a given temperature without detrimental mechanical effects. Thirdly the CNT is a long cylindrically shaped structure that places the tip far from the base whereas the silicon tip is essentially pyramidal. This allows the CNT to effectively provide a greater ratio of height/radius, a ratio that relates directly to the electric field enhancement factor of the structure, enabling the same emission field at a lower applied voltage for the CNT structure compared to a silicon tip.

All these factors notwithstanding, if a particular gated emitter design requires a lower emission current; for example if due to a smaller recorded spot size only 1/25 of the CNT maximum current is required, then the silicon tip may prove viable. Typical material parameters indicate a silicon tip emitter may be feasible at spot sizes smaller than 10 nanometers diameter. Accordingly, CNTs 720 and 320 may be replaced with silicon tip emitters in some embodiments. While this may require other modifications due to various engineering constraints, undue experimentation should not be necessary to make such a replacement.

In the foregoing detailed description, the method and apparatus of the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. For example, the various blocks of FIG. 6a may be integrated into components, or may be subdivided into components. Similarly, the blocks of FIG. 4 (for example) represent portions of a method that, in some embodiments, may be reordered or may be organized in parallel rather than in a linear or step-wise fashion. The present specification and figures are accordingly to be regarded as illustrative rather than restrictive.

1. An apparatus, comprising:
a substrate;
a carbon nanotube mounted on the substrate; and
an extraction electrode mounted in proximity to a tip of the carbon nanotube.

2. The apparatus of claim 1, further comprising:
a deflection electrode mounted in proximity to the tip of the carbon nanotube.

3. The apparatus of claim 1, further comprising:
an anode mounted away from the extraction electrode.

4. The apparatus of claim 1, further comprising:
a container mounted on the substrate in proximity to the tip of the carbon nanotube.

5. The apparatus of claim 4, wherein:
the container is formed of dielectric material.

6. The apparatus of claim 5, further comprising:
a detector mounted in proximity to a first end of the container opposite a second end of the container, the second end of the container mounted in proximity to the tip of the carbon nanotube.

7. The apparatus of claim 6, wherein:
the detector is a detector electrode.

8. The apparatus of claim 1, wherein:
the substrate has a cavity in a surface of the substrate and the carbon nanotube is mounted within the cavity.

9. The apparatus of claim 8, wherein:
the extraction electrode is mounted on the surface of the substrate surrounding the cavity.

10. The apparatus of claim 6, further comprising:
a window mounted on the first end of the container, the detector mounted on or near the window outside the container.

11-24. (canceled)

25. A method of forming a carbon nanotube-based read/write head, comprising:
placing a carbon nanotube on a substrate;
forming an electrode pattern in proximity to the carbon nanotube;
attaching a dielectric enclosure to the substrate with the enclosure circumscribing the electrode and the carbon nanotube;
sealing the dielectric enclosure in a vacuum with a window; and
forming a detector on a surface of the window opposite the enclosure.

26. The method of claim 25, further comprising:
forming an anode on the inner surface of the window that is attached to the enclosure.

27. The method of claim 25, further comprising:
forming an electrode pattern in proximity to the carbon nanotube.

28. The method of claim 25, wherein:
the electrode pattern includes a focus electrode and an extraction electrode.

29. The method of claim 25, wherein:
the carbon nanotube is placed within a cavity of the substrate.

30. (canceled)

31. An apparatus, comprising:
a substrate;
a carbon nanotube mounted on the substrate;
an extraction electrode mounted in proximity to a tip of the carbon nanotube;
a deflection electrode mounted in proximity to the tip of the carbon nanotube;
an anode mounted away from the extraction electrode.
a container mounted on the substrate in proximity to the tip of the carbon nanotube;
a detector mounted in proximity to a first end of the container opposite a second end of the container, the second end of the container mounted in proximity to the tip of the carbon nanotube; and
a window mounted on the first end of the container, the detector mounted on or near the window outside the container.

32. The apparatus of claim 31, wherein:
the container is formed of dielectric material.

33. The apparatus of claim 31, wherein:
the detector is a detector electrode.

34. The apparatus of claim 31, wherein:
the substrate has a cavity in a surface of the substrate and the carbon nanotube is mounted within the cavity.

35. The apparatus of claim 34, wherein:
the extraction electrode is mounted on the surface of the substrate surrounding the cavity.
